(19) United States
(12) Patent Application Publication
(10) Pub. No.: US 2015/0196011 A1
(43) Pub. Date: Jul. 16, 2015

(54) ANIMAL EXERCISE ASSIST DEVICE AND ANIMAL ACTIVITY INFORMATION MONITORING SYSTEM AND METHOD

(71) Applicant: Dogtra co., Ltd., Incheon (KR)

(72) Inventor: Min Jae SO, Seoul (KR)

(21) Appl. No.: 14/329,648

(22) Filed: Jul. 11, 2014

(30) Foreign Application Priority Data
Jan. 13, 2014 (KR) 10-2014-0003926

(51) Int. Cl. A01K 29/00

(52) U.S. Cl. CPC A01K 29/005

(57) ABSTRACT

An animal exercise assist device and animal activity information monitoring system and method are provided. The animal exercise assist device is mounted on an animal so as to assist exercise of the animal and includes: a sensing unit that measures movement of the animal; a control unit that generates activity information of the animal on the basis of a current degree of activity acquired by analyzing the movement; a memory that stores a target degree of activity of the animal and the activity information generated by the control unit; and a display unit that displays the activity information in a predetermined format. The display unit displays a ratio of the current degree of activity to the target degree of activity.

### CROSS-REFERENCE TO RELATED APPLICATIONS

This application claims the benefit of Korean Patent Application No. 10-2014-0003926, filed with the Korean Intellectual Property Office on Jan. 13, 2014, the disclosure of which is incorporated herein by reference in its entirety.

### BACKGROUND OF THE INVENTION

1. Field of the Invention

The present invention relates to an animal exercise assist device and animal activity information monitoring system and method.

2. Description of the Related Art

In recent years, ubiquitous healthcare (U-health) services have been studied more and more which couple patients and doctors to provide health and medical care in real time using information communication networks such as the Internet, mobile phones, and interactive cable TVs regardless of times and places.

In addition to services of measuring blood pressure, blood sugar, and body temperature, diagnostic image, prescription, and treatment details are provided to doctors and services of medication prescription, healthcare such as menu management, emergency transport, and the like can be provided. As a representative U-health service, Google Health is also known which provides a periodic health check and relevant news when personal health information is input to an Internet homepage.

With a recent increase of small families, homes in which a pet such as a dog and a cat is kept tend to increase more and more. However, studies have been actively made on the fields of physical activity analysis and monitoring as described above, but studies on the fields of activity analysis and monitoring of pets have not been actively made.

US Patent Application Publication No. 2004/0167386 discloses an animal healthcare system that receives an input of a weight of an animal, measures impedance, receives an input of an inter-leg distance is input, and evaluates health of the animal. However, this technique requires particular analysis equipment, and since weight and impedance are used, there is a limitation that the analysis thereof is not slightly associated with physical activities of animals.

Therefore, there is a need for an animal healthcare device that can analyze physical activities of pets such as dogs and cats and inform their owners of the analysis result to help the pets to maintain their health.

The above-mentioned related art is technical information which is thought out to make the invention or is learned by the inventor in the course of making the invention, but cannot be thus said to be technical information known to the public before filing the invention.

### SUMMARY

An object of the present invention is to provide an animal exercise assist device that is mounted on an animal, measures and analyzes an activity of the animal, provides the analysis result to an owner of the animal so as to easily recognize the analysis result, give a stimulation to the animal so as to take exercise corresponding to a predetermined target degree, and assists the animal to actively take exercise.

Another object of the present invention is to provide animal activity information monitoring system and method that receives measurement and analysis results of an animal, provides the results to an owner of the animal, and provides distinct notices depending on the degree of activity so as to cause the owner to exercise the animal.

Other objects of the invention will be easily understood from the following description.

According to an aspect of the invention, there is provided an animal exercise assist device that is mounted on an animal so as to assist exercise of the animal, including: a sensing unit that measures movement of the animal; a control unit that generates activity information of the animal on the basis of a current degree of activity acquired by analysing the movement; a memory that stores a target degree of activity of the animal and the activity information generated by the control unit; and a display unit that displays the activity information in a predetermined format, wherein the display unit displays a ratio of the current degree of activity to the target degree of activity.

The display unit may include: a front cover in which a main hole is formed at the center thereof and a plurality of slots are arranged in a radial shape around the main hole; a main light-emitting unit that is disposed in the main hole; and a sub light-emitting unit that is disposed in each of the plurality of slots.

The display unit may display the ratio by causing only the slots of the number corresponding to the ratio out of the plurality of slots to emit light.

The animal exercise assist device may further include a communication unit that performs short-range communication with a monitoring terminal having an animal activity monitoring application installed therein, and the control unit may transmit the activity information to the monitoring terminal through the use of the communication unit, may receive setting information on a display format of the display unit from the monitoring terminal, and may store the received setting information in the memory.

The animal exercise assist device may further include a speaker that outputs a predetermined audio signal when the ratio of the current degree of activity to the target degree of activity is less than a predetermined reference value set for each designated time point.

The audio signal may be a high-frequency signal that is able to be recognized by the animal.

Alternatively, the animal exercise assist device may further include a stimulation generating unit that generates and provides predetermined animal stimulation to the animal when the ratio of the current degree of activity to the target degree of activity is less than a predetermined reference value set for each designated time point, and the animal stimulation may be at least one of electrical stimulation and physical stimulation.

According to another aspect of the invention, there is provided an animal exercise assist device including: a front cover in which a main hole is formed at the center thereof and a plurality of slots are arranged in a radial shape around the main hole; a main light-emitting unit that is disposed in the main hole; a sub light-emitting unit that is disposed in each of the plurality of slots; and a control unit that controls turning-on and turning-off of the main light-emitting unit and the sub light-emitting units.

The main light-emitting unit may be able to display a plurality of colors by combining a plurality of light emitting diodes (LEDs), and the sub light-emitting units may have one LED for each slot.

According to still another aspect of the invention, there is provided an animal activity monitoring terminal including: a communication unit that performs short-range communication with the above-mentioned animal exercise assist device; a data processing unit that performs a data process on the activity information on the basis of a predetermined data processing method, generates statistical analysis data correlated with a measurement time point, and calculates a ratio of a current degree of activity to a target degree of activity; a screen output unit that outputs the statistical analysis data and the ratio generated by the data processing unit to a terminal screen; and an audio output unit that outputs predetermined warning sound or melody when the ratio is less than a predetermined reference value.

The audio output unit may be set to output the warning sound or melody with at least one of type and intensity thereof varying depending on the ratio so as to cause a user to recognize the current degree of activity of the animal by only listening to the warning sound or melody.

According to still another aspect of the present invention, there is provided an animal activity monitoring method in an animal exercise assist device that is mounted on an animal so as to assist exercise of the animal, including the steps of: causing a sensing unit to measure movement of the animal and to generate activity data; causing a control unit to analyze the activity data to determine an activity type of the animal and to calculate a degree of activity of the animal to generate activity information; displaying the activity information through the use of a display unit so as to cause a user to recognize the activity information; comparing the degree of activity with a target degree of activity; and displaying the comparison result with the target degree of activity in a ratio displaying format through the use of the display unit, wherein the display unit displays the ratio by causing only the slots of the number corresponding to the ratio out of the plurality of slots to emit light.

The animal activity monitoring method may further include a step of outputting a predetermined output sound or high-frequency sound or generating and outputting animal stimulation when the current degree of activity is less than the target degree of activity.

Other aspects, features, and advantages of the invention will become apparent from the accompanying drawings, the appended claims, and the detailed description of the invention.

According to the aspects of the invention, it is possible to provide an animal exercise assist device that is mounted on an animal, measures and analyzes an activity of the animal, provides the analysis result to an owner of the animal so as to easily recognize the analysis result, give a stimulation to the animal so as to take exercise corresponding to a predetermined target degree, and assists the animal to actively take exercise.

It is also possible to provide animal activity information monitoring system and method that receives measurement and analysis results of an animal, provides the results to an owner of the animal, and provides distinct notices depending on the degree of activity so as to cause the owner to exercise the animal.

### BRIEF DESCRIPTION OF THE FRAMINGS

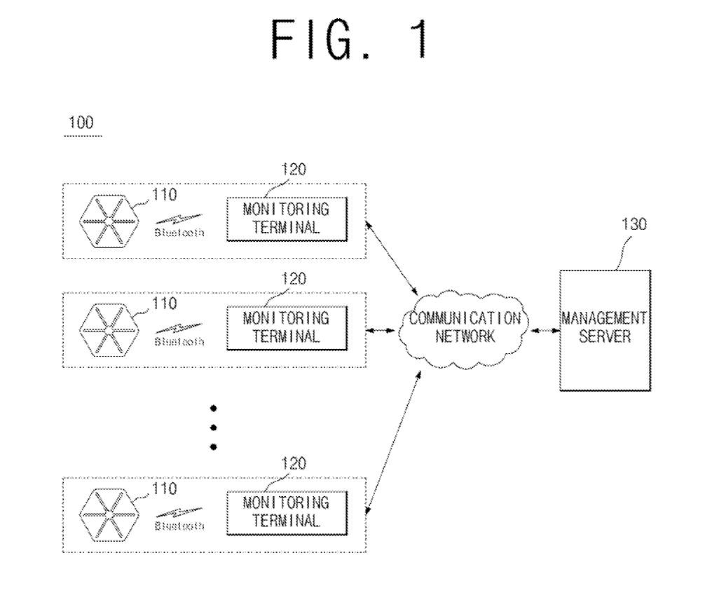

FIG. 1 is a diagram schematically illustrating a configuration of an animal activity monitoring system according to an embodiment of the invention.

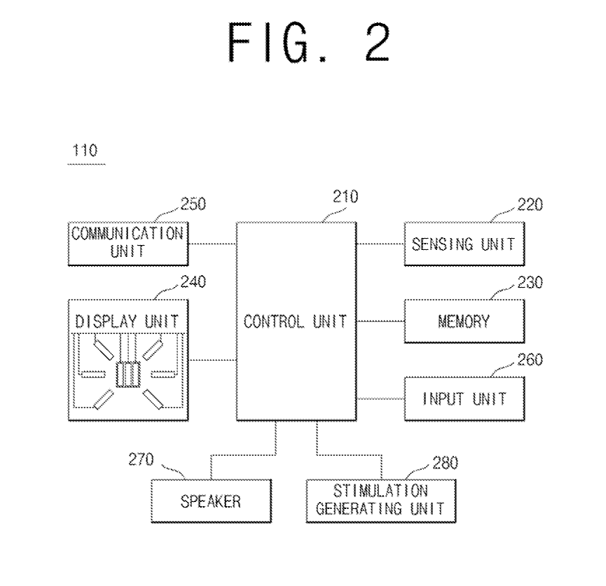

FIG. 2 is a block diagram schematically illustrating a configuration of an animal exercise assist device according to an embodiment of the invention.

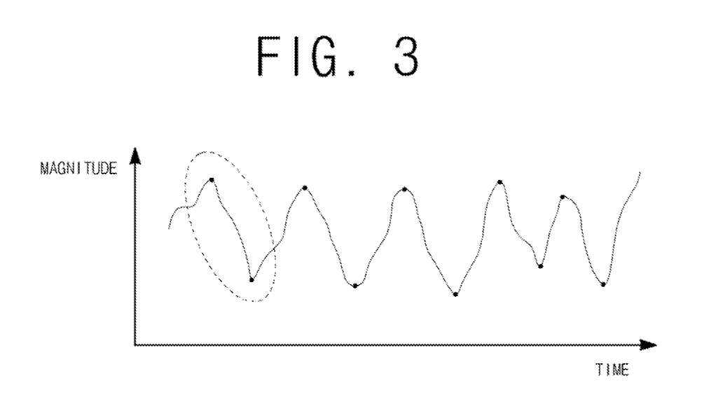

FIG. 3 is a diagram illustrating sensing and analysis of an animal activity according to an embodiment of the invention.

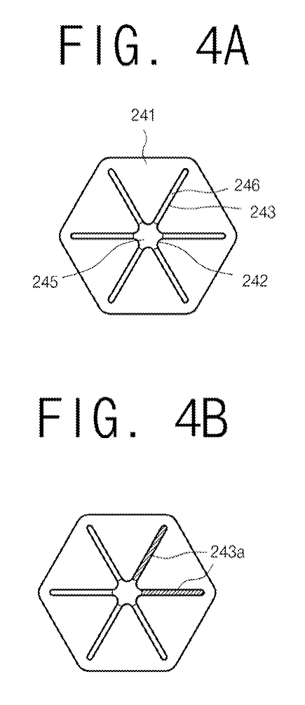

FIGS. 4A and 4B are diagrams illustrating display formats in a display unit of an animal exercise assist device according to the embodiment of the invention.

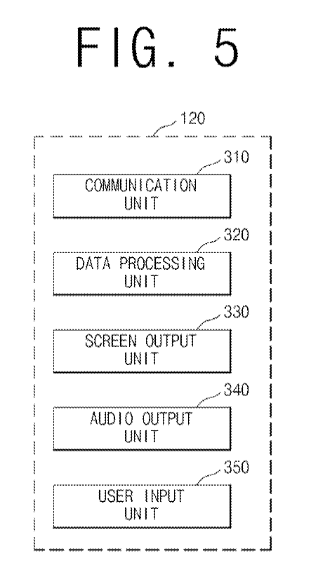

FIG. 5 is a block diagram schematically illustrating a configuration of a monitoring terminal according to an embodiment of the invention.

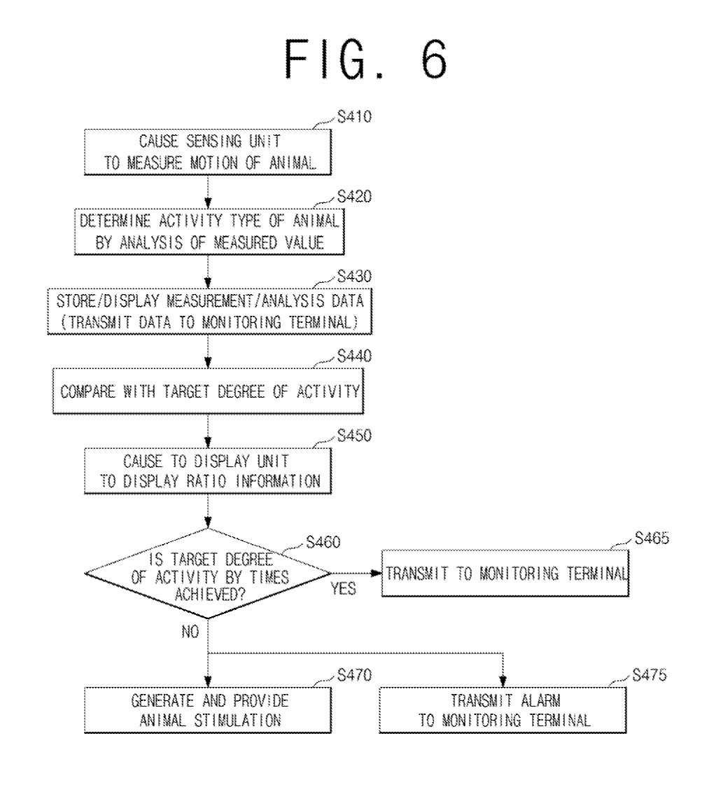

FIG. 6 is a flowchart illustrating an animal activity monitoring method according to an embodiment of the invention.

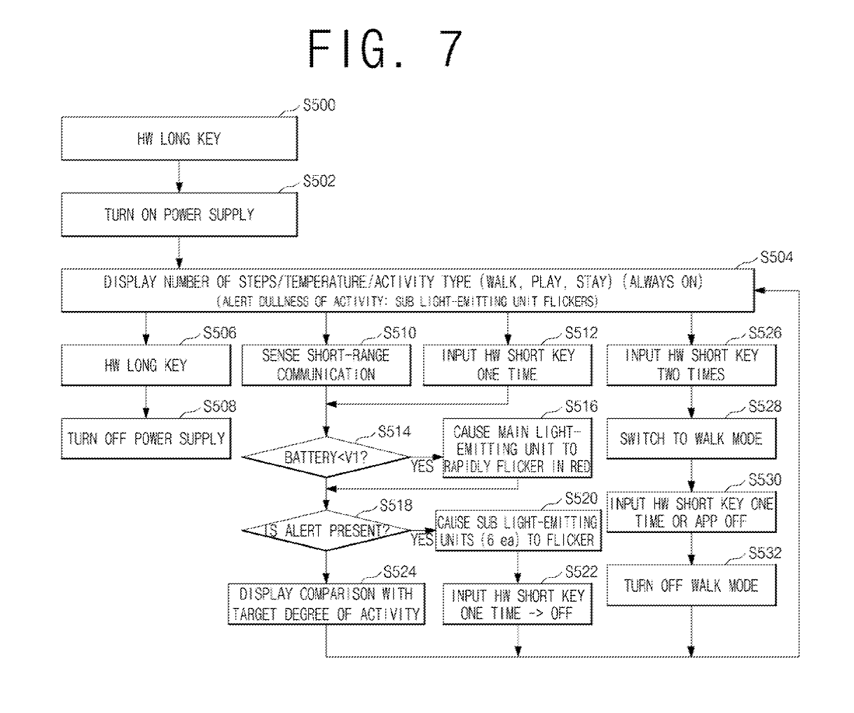

FIGS. 7 to 9 are diagrams illustrating operation scenarios in an animal exercise assist device according to an embodiment of the invention.

### DESCRIPTION OF EXEMPLARY EMBODIMENTS OF THE INVENTION

The invention can be modified in various forms and specific embodiments will be described and shown below. However, the embodiments are not intended to limit the invention, but it should be understood that the invention includes all the modifications, equivalents, and replacements belonging to the concept and the technical scope of the invention.

If it is mentioned that an element is “connected to” or “coupled to” another element, it should be understood that still another element may be interposed therebetween, as well as that the element may be connected or coupled directly to another element. On the contrary, if it is mentioned that an element is “connected directly to” or “coupled directly to” another element, it should be understood that still another element is not interposed therebetween.

The terms used in the following description are intended to merely describe specific embodiments, but not intended to limit the invention. An expression of the singular number includes an expression of the plural number, so long as it is clearly read differently. The terms such as “include” and “have” are intended to indicate that features, numbers, steps, operations, elements, components, or combinations thereof used in the following description exist and it should thus be understood that the possibility of existence or addition of one or more other different features, numbers, steps, operations, elements, components, or combinations thereof is not excluded.

Terms “first”, “second”, and the like can be used to describe various elements, but the elements should not be limited to the terms. The terms are used only to distinguish an element from another.

Terms “unit”, “module”, and the like described in the specification mean a unit for performing at least one function or operation and can be embodied by hardware, by software, or by a combination of hardware and software.

Elements of an embodiment described below with reference to the accompanying drawings are not limited to the corresponding embodiment, may be included in another embodiment without departing from the technical spirit of the invention. Although particular description is not made, plural embodiments may be embodied as one embodiment.

In describing the invention with reference to the accompanying drawings, like elements are referenced by like reference numerals or signs regardless of the drawing numbers and description thereof is not repeated. When it is determined that detailed description of known techniques involved in the invention makes the gist of the invention obscure, the detailed description thereof will not be made.

FIG. 1 is a diagram schematically illustrating a configuration of an animal activity monitoring system according to an embodiment of the invention. An animal activity monitoring system 100, animal exercise assist devices 110, monitoring terminals 120, and a management server 130 are illustrated in FIG. 1.

The animal activity monitoring system 100 according to an embodiment of the invention is a system of providing an animal activity monitoring services of measuring and analyzing activities of animals and displaying the results so as to allow users to recognize the results and includes animal exercise assist devices 100 and monitoring terminals 120. The animal activity monitoring system 100 may further include the management server 130.

One animal exercise assist device 110 and one monitoring terminal 120 can be grouped into one set and transmit and receive data by short-range communication such as Bluetooth.

The animal exercise assist device 110 is a device that can be mounted on a collar (or necklace) of a pet (such as a dog and a cat) and can measure and analyze motions of the animal.

The animal exercise assist device 110 may be provided with a display unit, a speaker, and the like that enables a user (for example, an owner of a pet) to intuitively recognize the measured and analyzed animal activity data.

The animal exercise assist device 110 may assist exercise of an animal having the animal exercise assist device mounted thereon by providing stimulation to the animal depending on the animal activity analysis result to cause the animal to take activity corresponding to a predetermined target degree of activity.

The monitoring terminal 120 is an electronic terminal having an application for monitoring animal activity installed therein. Here, the electronic terminal may be one of a smart phone, a mobile communication terminal, a personal digital assistant (PDA), a general-purpose personal computer (PC), a notebook PC, and a tablet PC in which an operating system capable of driving an application for providing an animal activity monitoring service is installed.

The monitoring terminal 120 receives the measurement and analysis result of a pet having the animal exercise assist device 110 mounted thereon, displays the received result so as to cause the owner of the pet to confirm the result from various points of view, and provides distinct notices depending on the degree of activity so as to cause the user to exercise the pet when the degree of activity is deficient.

The monitoring terminal 120 receives an input of a target degree of exercise of the pet from the user, transmits the target degree of exercise to the animal exercise assist device 110 so as to store the target degree of exercise in the memory thereof.

The management server 130 stores user profiles and stores a variety of data (for example, animal types, sexes, residences, heights, weights, and ages) of pets which are kept by subscribers of the animal activity monitoring service in a database.

The management server 130 communicates with one or more monitoring terminals 120 via wired or/and wireless networks, collects activity data of the pets, and stores the collected activity data in correlation with the pets stored in the database.

The animal activity data stored in the database is a large amount of data relevant to the plural pets which are kept by plural users and corresponds to big data. A variety of statistical analysis can be carried out by animal types, times, seasons, ages, sexes, residences, heights, weights, and the like on the basis of various big data processing algorithms.

A pet of a user can be compared with pets of other users in the degree of activity.

The animal exercise assist device 110 and the monitoring terminal 120 will be described below in detail with reference to the accompanying drawings.

FIG. 2 is a block diagram schematically illustrating a configuration of an animal exercise assist device according to an embodiment of the invention, FIG. 3 is a diagram illustrating sensing and analysis of an animal activity according to the embodiment of the invention, and FIGS. 4A and 4B are diagrams illustrating display formats in a display unit of an animal exercise assist device according to the embodiment of the invention.

Referring to FIGS. 2 and 4, an animal exercise assist device 110, a communication unit 250, a sensing unit 220, a memory 230, an input unit 260, a display unit 240, a control unit 210, a speaker 270, a stimulation generating unit 280, a front cover 241, a main hole 242, slots 243, a main light-emitting unit 245, and sub light-emitting units 246 are illustrated.

The animal exercise assist device 110 according to an embodiment of the invention includes the communication unit 250, the sensing unit 220, the memory 230, the display unit 240, and the control unit 210. The animal exercise assist device 110 may further include one or more of the input unit 260, the speaker 270, and the stimulation generating unit 280 if necessary.

The sensing unit 220 measures movement (activity) of an animal having the animal exercise assist device 110 mounted thereon. The sensing unit 220 may be, for example, an accelerometer, processes an output signal based on movement of the animal to measure dynamic forces such as acceleration, vibration, and impact of the animal and to generate activity data relevant thereto.

The sensing unit 220 may additionally measure an external temperature.

The control unit 210 analyses the activity data measured by the sensing unit 220 and determines the activity type of the animal such as the number of steps.

FIG. 3 illustrates a dynamic displacement graph of the animal measured by the sensing unit 220. The dynamic displacement graph expresses the activity data, in which the horizontal axis represents the time and the vertical axis represents the displacement magnitude.

The highest point and the lowest point adjacent in the dynamic displacement graph is a variation in displacement caused by one step of an animal (four-leg animal). Accordingly, the control unit 210 can acquire the number of steps of the animal by counting the number of highest points and/or lowest points in the activity data.

The control unit 210 can analyze the activity type of an animal from the time interval between the steps. Examples of the activity type of an animal include play, walk, and stay.

In this case, it can be analyzed that the animal jumps in the play state when the time interval between steps is small, and the animal slowly walks in the walk state when the time interval between steps is large. It can be analyzed that the animal stays in the stay state when there is no step for a predetermined time.

When the control unit 210 counts the number of steps, the number of steps may be reset for each predetermined time point. For example, the number of steps may be reset for each day and it may be understood what degree of activity the animal takes per one day.

Referring to FIG. 2 again, the activity data measured by the sensing unit 220 and the number of steps and the activity type of the animal analyzed by the control unit 210 are stored in the memory 230. This information can be stored in correlation with the measurement time point and this correlation can be used to analyze the activity type of the animal by time zones.

The communication unit 250 performs short-range communication with the monitoring terminal 120 and transmits the animal activity information including one or more of the activity data measured by the sensing unit 220 and the number of steps and the activity type of the animal analyzed by the control unit 210 to the monitoring terminal 120.

Setting information may be received from the monitoring terminal 120 and may be stored in the memory 230, an output state (for example, color, flickering period, and lighting order) from the display unit 240 to be described later may be changed by the control unit 210, an output state (for example, type and volume of output sound) form the speaker 270 may be changed, or an output state (for example, stimulation type, stimulation intensity, and stimulation providing period) from the stimulation generating unit 280 may be changed.

At this time, the communication unit 250 and the monitoring terminal 120 may transmit and receive data only when the communication therebetween is allowed. That is, the animal exercise assist device 110 has specific identification information and data communication of the monitoring terminal 120 may be permitted with only the communication unit 250 of the animal exercise assist device 110 having identification information corresponding to the registered identification information.

The display unit 240 is controlled by the control unit 210 and displays a variety of information to the user.

The display unit 240 may include a front cover 241 in which a main hole 242 is formed at the center and plural slots 243 are arranged in a radial shape as illustrated in FIG. 4A.

In the drawing, the number of slots 243 is set to six, but this is only an example. The number of slots may be three to five or seven or more. In the below description, it is assumed that the number of slots 243 is six.

The front cover 241 has a hexagonal shape corresponding to the number of slots 243 and vertexes are located in the extension directions of the slots 243.

The shape of the main hole 242 and the slots 243 may be a snow crystal or asterisk shape. The main light-emitting unit 245 is disposed in the main hole 242 of the front cover 241, and the sub light-emitting units 246 are arranged in the six slot 243, respectively.

The main light-emitting unit 245 can display plural colors by combining plural LEDs. For example, three LEDs may be combined to display seven colors.

The sub light-emitting units 246 include six LEDs and an LED is disposed for each slot 243.

The user can intuitively understand information by changing a display color of the main light-emitting unit 245, changing the number/period of flickering of the main light-emitting unit 245 and the sub light-emitting units 246, adjusting the number of slots emitting light of the sub light-emitting units 246, and the like depending on the information to be displayed under the control of the control unit 210.

For example, the animal exercise assist device 110 operates with a battery as a power source, and may set the display color of the main light-emitting unit 245 to be red and to flicker with low brightness (for example, 13% or 23%) when displaying a state of charge of the battery. The number of flickering times may be set to 10 times when the state of charge of the battery is 10% to 20%, and the flickering period may be set to a half and the nummber of flickering times may be set to 20 when the state of charge of the battery further decreases (0% to 10%) (battery display mode).

When a target degree of activity for a predetermined time (for example, a day) is set for an animal, the ratio of the current degree of activity to the target degree of activity may be displayed as a ratio of the number of slots emitting light to the total number of slots (target degree display mode).

By using a method of causing the slots 243 of the sub light-emitting units 246 to sequentially emit light one by one, when n slots out of six slots emit light, the user can intuitively understand that the current degree of activity is about n/6 of the target degree of activity of an animal.

Alternatively, one slot may emit light when the current degree of activity of the animal ranges from 0% to 20%, two slots may emit light when the current degree of activity of the animal ranges from 20% to 40%, three slots may emit light when the current degree of activity of the animal ranges from 40% to 60%, four slots may emit light when the current degree of activity of the animal ranges from 60% to 80%, five slots may emit light when the current degree of activity of the animal ranges from 80% to 100%, and six slots may emit light when the current degree of activity of the animal is greater than 100%.

FIG. 4B illustrates a state where the number of slots emitting light is two. When only two slots 243a out of six slots 243 emit light, the user can visually confirm the state at a distant place and can recognize that the animal takes activity corresponding to 2/6 of the target degree of activity. When the current degree of activity is deficient, the user can exercise the animal and thus the display 240 can serve as an exercise assist device for indirectly exercising the animal.

When a notice is provided to the user, the display unit 240 may flicker for a predetermined time while adjusting the brightness thereof in multiple stages (for example, 20%, 40%, 60%, 80%, and 100%) (alarm mode).

When the animal takes a walk, the main light-emitting unit 245 may serve as a safety lamp for flickering in a predetermined color to notify the presence of the animal in a walkway at night and preventing collision with other pedestrians (walk mode).

The main light-emitting unit 245 and the slots 243 of the sub light-emitting units 246 may be sequentially turned on or turned off to display ON and OFF of the power source of the animal exercise assist device 110 (power source ON/OFF mode).

When the battery of the animal exercise assist device 110 is charged, the main light-emitting unit 245 may be turned on to display the charging state. The sub light-emitting units 246 may display the state of charge for the user by adjusting the ratio of the slots emitting light to the total slots depending on the state of charge (charging mode).

When the number of steps of the animal measured for a predetermined time is less than a predetermined number, the main light-emitting unit 245 and/or the sub light-emitting lights 246 may flicker to give an alert to the user (alert mode). For example, when 50 steps are not measured for every 30 minutes, the alert operation may be carried out.

Setting information input through the communication unit 250 may be stored or updated in the memory 230.

Animal activity information such as the activity data sensed by the sensing unit 220 and the number of steps and the activity type analyzed by the control unit 210 may be stored in the memory 230. The animal activity information may be stored in correlation with the measurement times.

The input unit 260 is a physical key or button disposed in the animal exercise assist device 110 and receives various inputs from the user.

For example, when a long key is input in which a key is pressed for a predetermined time or more, the power source is turned on/off for operation in the power source on/off mode.

When a short key is input in which a key is pressed for less than a predetermined time, the operations may be distinct depending on the number of times of pressing. The animal exercise assist device may operated in a current state notice mode (such as a battery display mode, an alert mode, and a target degree display mode) such as displaying of exhaustion of the battery, presence of alert, and a target degree of activity when the short key is input one time, and the animal exercise assist device may operate in a walk mode when the short key is input two times.

The speaker 270 outputs a predetermined output sound under the control of the control unit 210.

The control unit 210 may control the speaker so as to output an output sound capable of stimulate the animal when the ratio of the current degree of activity to the target degree of activity is deficient as the analysis result for each designated time point. For example, the output sound output from the speaker 270 may be a high-frequency sound capable of being heard by animals.

Here, the target degree of activity as a comparison reference may be a target degree of activity for each time point that is expected to be achieved up to a designated time point. For example, when a target degree of activity for a day is 10000 steps, the target degree of activity for each time point at the noon may be 5000 (=10000*0.5) steps.

Initially, the user causes the animal to take physical activities such as a walk to increase the degree of activity of the animal whenever the output sound stimulating the animal is output from the speaker 270. Then, the animal will take physical activities of increasing the degree of activity by a conditional reflex when the output sound is output.

That is, the speaker 270 may serve as an exercise assist device for increasing the deficient degree of activity of the animal.

The stimulation generating unit 280 generates and provides a predetermined stimulation to the animal under the control of the control unit 210. Examples of the stimulation generated by the stimulation generating unit 280 include an electrical stimulation and a physical stimulation.

Initially, the user causes the animal to take physical activities such as a walk to increase the degree of activity of the animal whenever the stimulation is applied to the animal. Then, the animal will take physical activities of increasing the degree of activity by a conditional reflex when the stimulation is applied to the animal.

That is, the stimulation generating unit 280 may serve as an exercise assist device for increasing the deficient degree of activity of the animal.

The animal exercise assist device 110 according to this embodiment includes a USB port and may charge the battery in an USB interface manner.

The animal exercise assist device 110 is connected to a computer in the USE interface manner to perform a backup operation of a variety of data stored in the memory 230, the setting operation of the animal exercise assist device 110, and the like.

FIG. 5 is a block diagram schematically illustrating the configuration of a monitoring terminal according to an embodiment of the present invention.

The monitoring terminal 120 according to this embodiment receives activity data measured and analyzed by the animal exercise assist device 110 by short-range communications with the animal exercise assist device 110 illustrated in FIG. 2, processes the data to confirmation of the user from various points of view, and displays the processing result on a screen or outputs the processing result in audio.

Referring to FIG. 5, the monitoring terminal 120 according to this embodiment includes a communication unit 310, a data processing unit 320, a screen output unit 330, an audio output unit 340, and a user input unit 350.

The communication unit 310 performs short-range communication with the animal exercise assist device 110. The communication unit receives the activity data of an animal from the animal exercise assist device 110 by short-range communication and transmits setting information input through the user input unit 350 to the animal exercise assist device 110.

The communication unit 310 can communicate with the management server 130 via a wired/wireless communication network and transmits the activity data of the animal along with user identification information to the management server 130. The communication unit may receive analysis information on animals of other users (for example, statistical analysis data based on a big data process) from the management server 130.

The data processing unit 320 processes the activity data received via the communication unit 310 in a predetermined data processing method and converts the activity data into information of various points of view.

For example, the data processing unit generates statistical analysis data such as the accumulated step number value for each day, for each month, and for each time zone in correlation with the measurement time point at which the number of steps of the animal is measured, or calculates the ratio of the current degree of activity (the current number of steps) to the target degree of activity (the target number of steps).

The information converted by the data processing unit 320 may be displayed on the screen in various formats such as a circular chart, a histogram, a cumulative frequency distribution chart, and a table of cumulative frequency distribution so as to allow the user to confirm the information.

For example, absolute evaluation data of the current degree of activity of the animal and relative evaluation data as the comparison result with the degrees of activity of other similar animals may be displayed on the main screen together. The absolute evaluation data may include the number of steps indicating the current degree of steps and the achievement ratio to the target degree of activity. The relative evaluation data may include resultant data as the comparison result of the average degree of activity of an animal group selected by classification of animal type, residence, age, sex, and the like with the current degree of activity of the current target animal (for example, total rank and percentage).

When the ratio of the current degree of activity to the target degree of activity calculated by the data processing unit 320 is not greater than a predetermined reference, a predetermined warning sound or melody may be output from the audio output unit 340.

In this case, by setting the type, intensity, and the like of the warning sound or melody to differ depending on the ratio to the target degree of activity, the user can easily recognize the degree of activity of the pet by only hearing the warning sound or melody.

The user input unit 350 includes a key button and a touch screen and receives various inputs from the user.

The user input unit 350 may receive a target degree of activity, the color, the flickering cycle, and the number of flickering times of the main light-emitting unit (245)/the sub light-emitting units 246 of the animal exercise assist device 110, the type, the volume, and the time of the output sound using the speaker 270, the type, the intensity, and the time of stimulation using the stimulation generating unit 280 as the setting information. This setting information may be transmitted to the animal exercise assist device 110 via the communication unit 310.

FIG. 6 is a flowchart illustrating an animal activity monitoring method according to an embodiment of the present invention.

The steps illustrated in FIG. 6 can be performed by the elements of the animal exercise assist device 110.

First, the sensing unit 220 senses movement of an animal and generates activity data (step S410). The sensing unit 220 may measure an external temperature.

The control unit 210 analyzes the activity data and identifies the animal activity type (step S420). For example, the animal activity type may be classified into play, walk, and stay.

The control unit 210 stores the analysis result in the memory 230 and displays the analysis result on the display unit 240 so as to allow the user to recognize the analysis result (step S430). The configuration and the display method of the display unit 240 are the same as described in detail with reference to FIGS. 4A and 4B.

When a monitoring terminal 120 is located within a short distance, animal activity information as the current analysis result (such as the number of steps, the control unit 210 may transmit the activity type, and the external temperature) may be transmitted to the monitoring terminal 120 via the communication unit 250.

Then, the control unit 210 compares the current degree of activity (the number of steps) calculated as the analysis result with the target degree of activity (step S440). The target degree of activity may be set by the user and stored in advance in the memory 230.

The display unit 240 displays the ratio of the current degree of activity to the target degree of activity as the comparison result in a ratio display format (step S450). The ratio display format means that the ratio of the current degree of activity to the target degree of activity is displayed as the ratio of the number of slots emitting light to the total number of slots.

Thereafter, the control unit 210 determines whether the current degree of activity for each designated time point reaches the target degree of activity by time points (step S460).

When the target degree of activity is achieved and the monitoring terminal 120 is located within a short distance, the control unit may transmit target achievement success information to the monitoring terminal 120 via the communication unit 230 (step S465) so as for the monitoring terminal 120 to inform the user of the successful target achievement.

When the target degree of activity is not achieved, the control unit outputs an output sound or a high-frequency sound via the speaker 270 or generates and provides animal stimulation using the stimulation generating unit 280 (step S470).

When the monitoring terminal 120 is located within a short distance, the control unit may transmit target achievement failure information to the monitoring terminal 120 so as for the monitoring terminal 120 to inform the use of the target achievement failure.

FIGS. 7 to 9 are diagrams illustrating operation scenarios in the animal exercise assist device according to an embodiment of the present invention.

First, it is assumed that the power source of the animal exercise assist device 110 is turned off.

Referring to FIG. 7, when a long key is input via the input unit 260 (step S500), the power source of the animal exercise assist device 110 is turned on (step S502). For example, when the power source is turned on, the sub light-emitting units 246 may be sequentially turned on by slots and then the main light-emitting unit 245 may be turned on in the state where all of the main light-emitting unit 245 and the sub light-emitting units 246 are turned off.

Then, the sensing unit 220 measures movement of the animal and/or the external temperature and the control unit 210 analyses the measured data and determines the number of steps, the temperature, the activity type (walk, play, stay), and the like (step S504). When the activity is dull, the sub light-emitting units 246 may flicker a predetermined number of times (for example, 10 times) for warning.

When a long key is input via the input unit 260 (step S506), the power source is turned off (step S508). In this case, in the state where all of the main light-emitting unit 245 and the sub light-emitting units 246 are turned on, the sub light-emitting units 246 may be sequentially turned off by slots and then the main light-emitting unit 245 may be turned off.

In step S504, when a monitoring terminal 120 with which short-range communication is possible is sensed (step S510) or a short key is input via the input unit 260 (step S512), predetermined information pieces are sequentially checked.

First, a state of charge of the battery is checked (step S514), and when the state of charge of the battery is insufficient (battery<V1 (for example, 3.3 V), a warning display indicating the insufficiency of the battery is output (step S516). For example, the main light-emitting unit 245 may rapidly flicker in red for the warning.

Then, the presence of warning is checked (step S518). Here, when a predetermined number of steps of the animal is not measured for a predetermined time, warning may be given. At this time, the sub light-emitting units 246 may flicker to display the warning (step S520). When a short key is input one time (step S522), the warning display is stopped.

Then, the current degree of activity relative to the target degree of activity is displayed (step S254). In this case, the user may be made to easily recognize the current degree of activity using the ratio of the number of slots emitting light to the total number of slots of the sub light-emitting units 246.

When a short key is input two times in step S504 (step S526), the operation mode can be switched to the walk mode (step S528). In the walk mode, the main light-emitting unit 245 flickers with a predetermined cycle so as to display the walk and the sub light-emitting units 246 can display the current degree of activity as the ratio to the target degree of activity.

When a short key is input one time or an OFF signal is input from the monitoring terminal 120 (step S530), the walk mode is turned off (step S532).

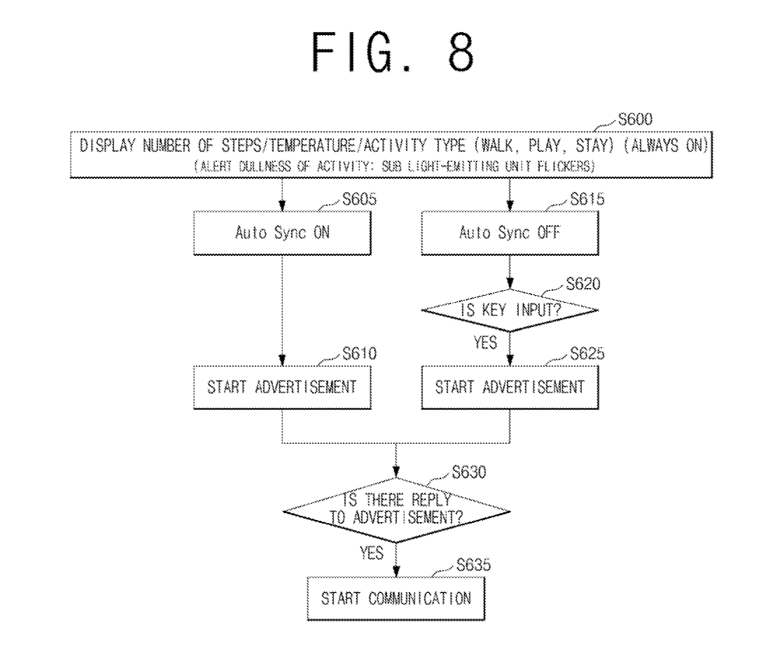

FIG. 8 illustrates the operations when the animal exercise assist device performs short-range communication with the monitoring terminal 120.

The sensing unit 220 of the animal exercise assist device 110 measures the animal movement and/or the external temperature, and the control unit 210 analyzes the measurement result and determines the number of steps, the temperature, and the activity type (walk, play, stay), and the like (step S600). When the activity is dull, the sub light-emitting units 246 may flicker a predetermined number of times (for example, 10 times) for warning.

At this time, when automatic synchronization (auto sync) is turned on (step S605), the monitoring terminal 120 may turn on a Bluetooth module and presence of the monitoring terminal 120 may be informed in accordance with a Bluetooth protocol.

Then, predetermined advertisement is played in the monitoring terminal 120 (step S610).

When the automatic synchronization is turned off (step S615), the control unit waits until a key input is performed (step S620). When a key input is performed, predetermined advertisement is played (step S625).

Only when a response to the played advertisement is given (step S630), the communication between the monitoring terminal 120 and the animal exercise assist device 110 may be started (step S635). As a result, an advertisement profit can be secured using the application of the monitoring terminal 120 and an additional profit may be created through advertisement of pet dog/pet cat products or the like.

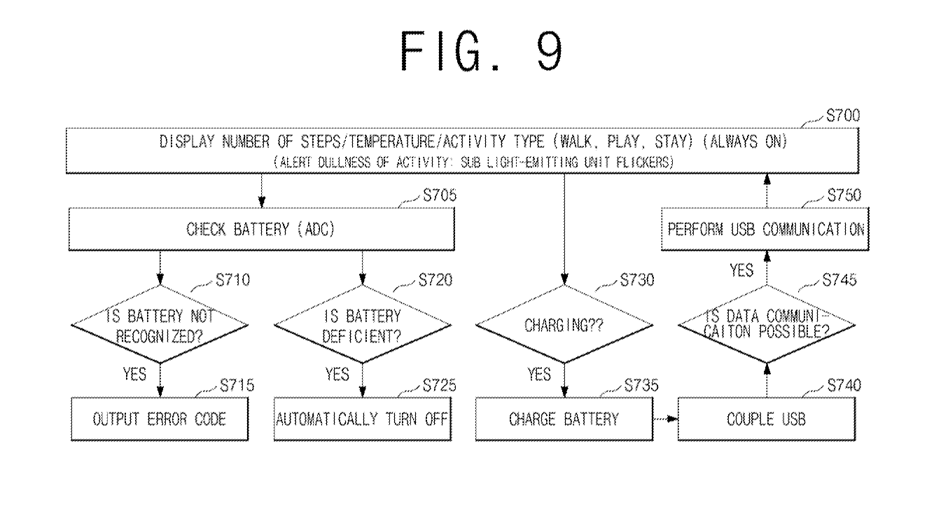

FIG. 9 illustrates a case where the animal exercise assist device 110 is charged or USB communication is performed.

The sensing unit 220 of the animal exercise assist device 110 measures the animal movement and/or the external temperature, and the control unit 210 analyses the measurement result and determines the number of steps, the temperature, and the activity type (walk, play, stay) (step S700). When the activity is dull, the sub light-emitting units 246 may flicker a predetermined number of times (for example, 10 times) for warning.

The battery is checked (step S705), and when the battery is not recognized (step S710), an error code is output (step S715). When the state of charge of the battery is less than a predetermined reference (for example, 3%) (step S720), the power source is automatically turned off.

It is determined whether to charge the battery (step S730), when it is determined that the battery should be charged, the battery is charged up to a predetermined amount of charge (for example, 5 V) (step S735). When the USB is coupled (step S740), it is determined whether data communication is enabled (step S745). When it is determined that the data communication is enabled, the data communication is performed using the USB interface (step S750).

The above-mentioned animal activity monitoring method may be embodied as automated procedures based on the time-series order by a software program built in the animal exercise assist device, an application installed in the monitoring terminal. Codes and code segments of the program will be easily inferred by computer programmers skilled in the art. The program can be stored in a computer-readable recording medium and can be read and executed by a digital processor to embody the above-mentioned methods. The recording medium includes a magnetic recording medium, an optical recording medium, and a carrier wave medium.

While the invention is described above with reference to the embodiments, it will be understood by those skilled in the art that the invention can be modified and changed in various forms without departing from the concept and scope of the invention described in the appended claims.

What is claimed is:

1. An animal exercise assist device that is mounted on an animal so as to assist exercise of the animal, comprising:
a sensing unit that measures movement of the animal;
a control unit that generates activity information of the animal on the basis of a current degree of activity acquired by analysing the movement;
a memory that stores a target degree of activity of the animal and the activity information generated by the control unit; and
a display unit that displays the activity information in a predetermined format,
wherein the display unit displays a ratio of the current degree of activity to the target degree of activity.

2. The animal exercise assist device according to claim 1, wherein the display unit includes:
a front cover in which a main hole is formed at the center thereof and a plurality of slots are arranged in a radial shape around the main hole;
a main light-emitting unit that is disposed in the main hole; and
a sub light-emitting unit that is disposed in each of the plurality of slots.

3. The animal exercise assist device according to claim 2, wherein the display unit displays the ratio by causing only the slots of the number corresponding to the ratio out of the plurality of slots to emit light.

4. The animal exercise assist device according to claim 1, further comprising a communication unit that performs short-range communication with a monitoring terminal having an animal activity monitoring application installed therein,
wherein the control unit transmits the activity information to the monitoring terminal through the use of the communication unit, receives setting information on a display format of the display unit from the monitoring terminal, and stores the received setting information in the memory.

5. The animal exercise assist device according to claim 1, further comprising a speaker that outputs a predetermined audio signal when the ratio of the current degree of activity to the target degree of activity is less than a predetermined reference value set for each designated time point.

6. The animal exercise assist device according to claim 5, wherein the audio signal is a high-frequency signal that is able to be recognized by the animal.

7. The animal exercise assist device according to claim 1, further comprising a stimulation generating unit that generates and provides predetermined animal stimulation to the animal when the ratio of the current degree of activity to the target degree of activity is less than a predetermined reference value set for each designated time point,
wherein the animal stimulation is at least one of electrical stimulation and physical stimulation.

8. An animal exercise assist device comprising:
a front cover in which a main hole is formed at the center thereof and a plurality of slots are arranged in a radial shape around the main hole;
a main light-emitting unit that is disposed in the main hole;
a sub light-emitting unit that is disposed in each of the plurality of slots; and
a control unit that controls turning-on and turning-off of the main light-emitting unit and the sub light-emitting units.

9. The animal exercise assist device according to claim 8, wherein the main light-emitting unit is able to display a plurality of colors by combining a plurality of light emitting diodes (LEDs), and
wherein the sub light-emitting units have one LED for each slot.

10. An animal activity monitoring terminal comprising:
a communication unit that performs short-range communication with the animal exercise assist device according to any one of claims 1 to 7;
a data processing unit that performs a data process on the activity information on the basis of a predetermined data processing method, generates statistical analysis data correlated with a measurement time point, and calculates a ratio of a current degree of activity to a target degree of activity;
a screen output unit that outputs the statistical analysis data and the ratio generated by the data processing unit to a terminal screen; and
an audio output unit that outputs predetermined warning sound or melody when the ratio is less than a predetermined reference value.

11. The animal activity monitoring terminal according to claim 10, wherein the audio output unit is set to output the warning sound or melody with at least one of type and intensity thereof varying depending on the ratio so as to cause a user to recognize the current degree of activity of the animal by only listening to the warning sound or melody.

12. An animal activity monitoring method in an animal exercise assist device that is mounted on an animal so as to assist exercise of the animal, comprising the steps of:
causing a sensing unit to measure movement of the animal and to generate activity data;
causing a control unit to analyze the activity data to determine an activity type of the animal and to calculate a degree of activity of the animal to generate activity information;
displaying the activity information through the use of a display unit so as to cause a user to recognize the activity information;
comparing the degree of activity with a target degree of activity; and
displaying the comparison result with the target degree of activity in a ratio displaying format through the use of the display unit,
wherein the display unit displays the ratio by causing only the slots of the number corresponding to the ratio out of the plurality of slots to emit light.

13. The animal activity monitoring method according to claim 12, further comprising a step of outputting a predetermined output sound or high-frequency sound or generating and outputting animal stimulation when the current degree of activity is less than the target degree of activity.
